(19) United States
(12) Patent Application Publication
(10) Pub. No.: US 2007/0089303 A1
(43) Pub. Date: Apr. 26, 2007

(54) LOW NOSE SPROCKET AND CUTTING CHAIN

(75) Inventor: Sandra Graves, Lake Oswego, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Blount, Inc., Portland, OR (US)

(21) Appl. No.: 11/538,044

(22) Filed: Oct. 2, 2006

Related U.S. Application Data
(63) Continuation of application No. 10/626,250, filed on Jul. 23, 2003, now abandoned.

(51) Int. Cl. B27B 17/04

(52) U.S. Cl. 30/384

(57) ABSTRACT

An apparatus is provided for guide bars used in cutting operations, and more particularly to prolonging the life of the nose sprocket and/or reducing the tendency of guide bar separation in the nose sprocket region, by reconfiguring the nose sprocket outer race and/or the cutting chain drive tang.

### RELATED APPLICATION

The present application is a continuation application of utility application Ser. No. 10/626,250 filed on Jul. 23, 2003, entitled “LOW FIT NOSE SPROCKET AND CUTTING CHAIN,” and claims priority to said utility application. The specification of said application is also hereby fully incorporated by reference in its entirety, except for those sections, if any, that are inconsistent with this specification

### FIELD OF THE INVENTION

This invention relates to guide bars used in cutting operations, and more particularly to reducing the tendency of side wall separation in the nose sprocket region of the guide bar by reconfiguring the nose sprocket components and/or cutting chain drive links to improving the nose sprocket's resistance to side wall separation, and/or prolong the life of the nose sprocket.

### BACKGROUND OF INVENTION

Cutting chain guide bars are used in a variety of cutting operations. These operations include but are not limited to wood cutting by chain saws and tree harvesters, and aggregate cutting saws. Typically, one end of the guide bar is operably interconnected to a drive mechanism. The other end typically has a nose sprocket that allows the cutting chain to traverse the end of the guide bar. Nose sprockets are well known in the art and commonly consist of an outer race that has a number of teeth disposed about the periphery. The outer race has an inner bore that is sized to encompass an inner race. The inner bore is sized such that roller bearings can be trapped between the outer race and inner race, thereby enabling the outer race to rotate around the inner race. The nose sprocket is positioned between the guide bar side walls and secured between the side walls, usually by placing several rivets from one side wall to the other such that the rivets pass through the inner race.

Sprocket nose guide bars, and particularly of the type referred to as “laminate guide bars,” are susceptible to increased separation of the side walls at the nose end of the bar (sometimes referred to as “splitting of the side walls”). For example, during a cutting operation where the cutting chain is traversing the nose sprocket, the resistive forces of the material being cut tends to urge side deflection of the cutting chain relative to the nose of the bar. This side deflection can translate into a splitting force that urges increased opening or separation of the side walls, particularly at the nose end of the guide bar. This separation may provide an escape route for the bearings and ultimately render the guide bar inoperable. Thus there is a need to reduce the occurrence of side wall separation of the bar at the nose end of the chain saw guide bar.

In evaluating the causes of the undesirable side wall separation tendency, it has been found that by increasing the inner race diameter, one can move the rivets that secure the side walls together and hold the inner race in place closer to the outer periphery of the guide bar nose. Moving the rivets closer to the nose periphery provides greater resistance to the separation forces encountered by the side walls and ultimately reduces the tendency of the nose sprocket to fail.

Because the outer dimension of the outer race is substantially fixed, given the size of the guide bar and application, increasing the inner race diameter necessarily requires reducing the web width of the outer race, where the web width is the distance between the edge of the inner bore to the bottom of a gullet. Such a reduction potentially weakens the outer race and causes the sprocket teeth to be more susceptible to splitting due to the prying forces applied by the drive tangs of the cutting chain as they traverse the nose sprocket of the guide bar.

Thus there is an need to design a nose sprocket or cutting chain drive tang such that the rivets can be positioned closer to the periphery of the guide bar nose to prevent side wall separation, without weakening the outer race such that it becomes more susceptible to splitting.

### BRIEF DESCRIPTION OF THE INVENTION

The present invention helps solve the problem of side wall separation of the nose end of guide bars and can prolong the life of the nose sprocket. Whereas the problem concerns the location of the rivets, which location is dictated by the diameter of the inner race, it was reasoned that a strengthening of the outer race would permit a reduction in the web width and thus permit a larger inner race diameter to be used. The larger diameter enables the outward movement of the holding rivets, thus providing better resistance to side wall separation.

Analysis of the load distribution as applied to the outer race, determined that the sprocket tooth design could be improved with a variety of changes to the sprocket configuration, which would strengthen the outer race. These changes may include: (a) providing a relief at the upper portion of the teeth, which causes the moment arm of the affected tooth edge applied force vector to lower toward the bottom of the tooth (lowers the moment arm of that force); (b) providing the bottom curved gullet with a more shallow curve (greater radius of curvature), as a shallow versus a steeper curve (smaller radius of curvature) has greater resistance to splitting; and (c) providing a inverted or inwardly relieved portion on the upper edge portions of the cutting chain drive link tang. With the improvements described, a similar nose sprocket strength is retained with a lesser outer race web width, which allows for a greater diameter for the inner race without changing the outside dimension of the outer race. This in turn allows outward movement of the rivets and a lessening of the likelihood of side wall separation.

The present invention also may help prolong the life of the nose sprocket, regardless of the side wall separation concern. The changes identified above separately or together can strengthen the outer race by having the teeth better resist splitting as the forces will be applied to the lower stronger portion of the tooth.

These and other variations as well as the invention itself will become more readily apparent upon reference to the following detailed description that follows.

### BRIEF DESCRIPTION OF DRAWINGS

FIG. 1 is a side cross sectional view of a nose sprocket in accordance with one embodiment of the present invention;

FIG. 2 is an enlarged side cross sectional view of a portion of the nose sprocket of FIG. 1;

FIG. 3 is an enlarged side cross sectional view of a portion of an outer race in accordance with a second embodiment of the present invention;

FIG. 4 is an enlarged side cross sectional view of a portion of an outer race in accordance with a third embodiment of the present invention;

FIG. 5 is a side cross sectional view of a nose sprocket and cutting chain in accordance with a fourth embodiment of the present invention;

FIG. 6 is an enlarged side cross sectional view of a drive link tang of the cutting chain shown in FIG. 4; and

FIG. 7 is an enlarged side cross sectional view of a portion of an outer race in accordance with a fifth embodiment of the present invention.

### DESCRIPTION

In the following detailed description, reference is made to the accompanying drawings which form a part hereof wherein like numerals designate like parts throughout, and in which are shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

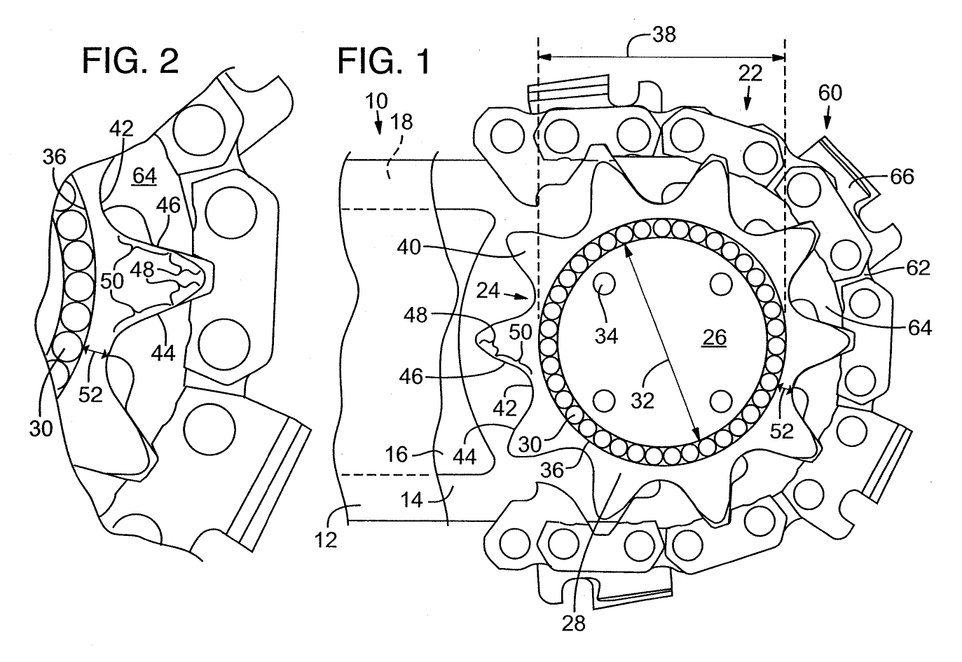

FIG. 1 is a side cross sectional view of a guide bar in accordance with the present invention. Guide bar 10 has opposable side walls 12,14. Core 16 may be disposed within side walls 12,14. A groove 18 is formed between side walls 12,14 with core 16 acting as the floor of groove 18. Guide bar 10 has a rear end (not shown) that is adapted for operational engagement with a machine, including but not limited to a chain saw tree harvester and/or an aggregate cutting saw. Guide bar 10-also has a nose end 22, opposite the rear end.

Disposed within the nose end 22 is a nose sprocket 24. Nose sprocket 24 may include an inner race 26, an outer race 28 and a plurality of bearings 30. Inner race 26 has a predetermined diameter 32, which may be dependent on factors such as guide bar size. Inner race 26 is fixed between side walls 12,14 such that inner race 26 does not move during operation. In the illustrated embodiment, inner race 26 is fixed between side walls 12,14 by a plurality of rivets 34. Rivets 34 also may help to secure side walls 12,14 in a fixed relation to each other and therefore may help to resist separation of side walls 12,14 at the nose end 22. In other embodiments, the inner race 26 may be fixed between side walls 12,14 by other means, including but not limited to welds, screws, metal fusion, high-strength adhesives and the like.

Outer race 28 has an inner bore 36, which has a bore diameter 38. Bore diameter 38 is greater than inner race diameter 32. This allows the outer race 28 to be rotatably disposed about the periphery of inner race 26. Bearings 30 are disposed between the peripheral edge of inner race 26 and the inner bore 36 of outer race 28, and enable the outer race 28 to rotate around fixed inner race 26.

Outer race 28 also has a plurality of teeth 40 disposed about its outer periphery. A gullet 42 is formed between adjacent teeth 40. Each tooth 40 has a leading edge 44 and a trailing edge 46. Cutting chain 60 may include a plurality of links or elements, such as cutting link 66 and drive link 62. Drive link 62 may have a tang 64 which is adapted to engage the portion of the outer race 28 formed by the leading edge 44 of a tooth 40, the gullet 42 and the trailing edge 46 of an adjacent tooth 40. Tooth 40 also has a lower portion 50 and a relieved upper portion 48. By providing a relief at the upper portion 48 of tooth 40, tang 64 is urged to engage the lower portion 50 of tooth 40. Such engagement helps ensure that the radial forces applied by drive link 62 and tang 64 caused during operation will be distributed to the lower portion 50 of outer race 28. This may result in an increased resistance to the splitting tendency of the outer race 28 caused by the prying forces applied to the teeth 40 as the cutting chain 60 traverses the nose end 22 of guide bar 10. Accordingly, this strengthening may prolong the life of the nose sprocket.

Strengthening outer race 28 not only can prolong the life of the nose sprocket 24, but may also enable web width 52 (width of material required between the inner bore 36 and the bottom of gullet 42) to be decreased without sacrificing operational strength. By decreasing the web width 52, the diameter of the inner race 32 can be correspondingly increased, thereby subsequently enabling positioning the rivets closer to the outer periphery of the nose end 22 of guide bar 10. This may increase the resistance of nose end 22 to side wall separation caused by the sideward deflection encountered by the cutting chain during cutting operations, without sacrificing operational life of the outer race 28.

FIG. 2 is an enlarged cross sectional view of the nose sprocket 24 shown in FIG. 1. Teeth 40 are shaped such that the upper portion 48 is slightly relieved when compared to the lower portion 50, both on the leading edge 44 and trailing edge 46. The relieved upper portion 48 of leading edge 44 and trailing edge 46 encourages the contact of tang 64 with the lower portion 50 of leading edge 44 and trailing edge 46 during operation. Tang 64 may also contact gullet 42, which also increases the strength of outer race 26. By urging contact of the tang 64 to the lower portions 50 and gullet 42, the operational forces will be directed to the stronger area of the outer race 28, which in turn may increase resistance of outer race 28 to splitting due to the prying forces typically caused by the drive tang 64 contact with the upper portions 48 of the leading edge 44 and trailing edge 46.

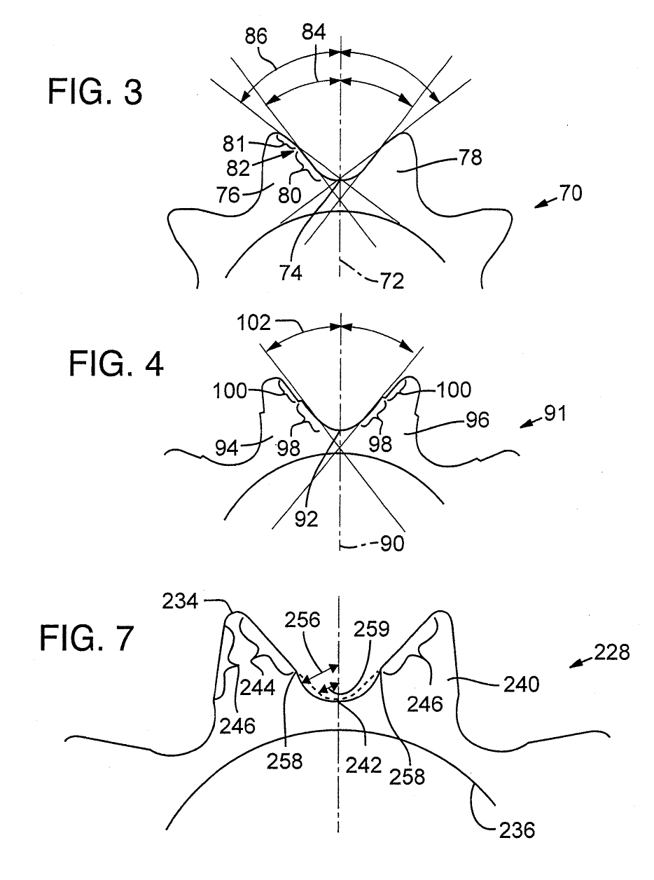

FIG. 3 is an enlarged side cross sectional view a portion of an outer race 70 in accordance with a second embodiment of the present invention. Center line 72 bisects gullet 74 formed between tooth 76 and adjacent tooth 78. The lower portion 80 of leading edge 82 of tooth 76 has a predetermined pitch, which forms a first angle 84 with respect to centerline 72. The upper portion 81 may have a different pitch, which forms a second angle 86 with respect to center line 72. Having second angle 86 being greater that first angle 84 may provide the necessary relief and urge the contact of the tang (not shown) toward the lower portion 80, thereby increasing the strength of outer race 70.

FIG. 4 illustrates an enlarged cross sectional view of an outer race in accordance with a third embodiment of the present invention. Center line 90 bisects gullet 92, which is formed between tooth 94 and adjacent tooth 96. Teeth 94, 96 have a lower portion 98 and a relieved upper portion 100. The pitch of the lower portion 98 has an angle 102 with respect to centerline 90. The pitch of the relieved upper portion 100 has approximately the pitch of the lower portion 98. The relief of the relieved upper portion 100 is formed by offsetting the relieved upper portion 100. Accordingly, the tang (not shown) may be urged to engage the lower portion 98 of tooth 94 and possibly the gullet 92.

It can be appreciated by one skilled in the art that the relief of the upper portion of the tooth need only be such that the tang is encouraged to contact the lower portion of the tooth at the leading and trailing edges in order to shift the operational forces lower on the tooth and gullet where the ability to resist the prying or splitting forces is increased. Again, this increases the strength of the outer race such that the nose sprocket life can be prolonged or the web width can be decreased to allow for an increase in the inner race diameter so that the rivets can be positioned closer to the nose end periphery to resist side wall separation.

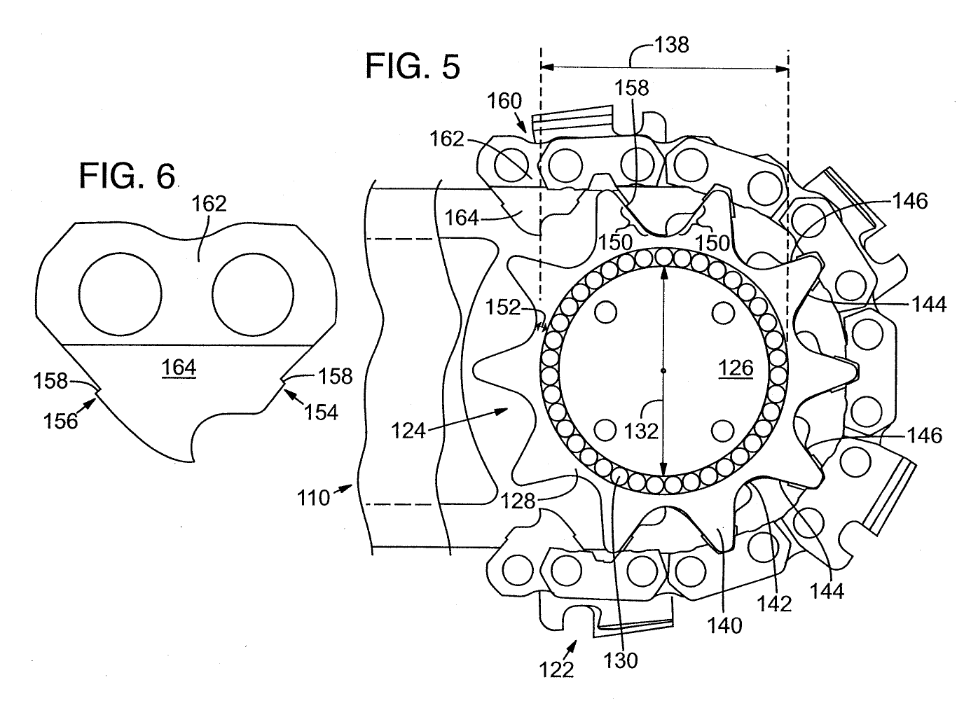

FIG. 5 is a side cross sectional view of a guide bar nose sprocket and cutting chain in accordance with a fourth embodiment of the present invention. Guide bar 110 is similar to that described with regard to FIG. 1. Nose sprocket 124 is disposed within the nose end 122 of guide bar 110. Nose sprocket 124 includes inner race 126, an outer race 128 and a plurality of bearings 130. The outer race 128 has a bore diameter 138 that is greater than inner race diameter 132, such that outer race 128 is rotatably disposed about the periphery of inner race 126. Outer race 128 also has a plurality of conventional teeth 140 disposed about the perimeter. The teeth 140 have a substantially uniform leading edge 144 and trailing edge 146, such that there is no discernible relief. Gullet 142 is formed by adjacent teeth 140 and is adapted to receive a tang 164 of a cutting chain 160.

To encourage application of the radial forces toward the lower portion 150 of the leading edge 144 and trailing edge 146, drive tang 164 may have inverted or inwardly relieved portions 158 formed therein. FIG. 6 is an enlarged cross sectional view of drive link 162 with tang 164 having inwardly relieved portions 158. Inwardly relieved portion 158 may be formed in the upper portion of tang leading edge 154 and upper portion of tang trailing edge 156. In other embodiments, relieved portions 158 can be more or less in set, tapered, or in other formations such that the lower portion of tang 164 is urged to contact the lower portion 150 of teeth 140.

Referring back to FIG. 5, the inwardly relieved portions 158 of tang 162 may cause the operational forces to be directed to lower portion 150 of teeth 140, which in turn may result in outer race 128 being more resistant to splitting and ultimately prolong the life of the nose sprocket. Also, web width 152 of outer race 128 may also be decreased without sacrificing the resulting strength. Reducing the web width 152 can then allow the inner race diameter 132 to be increased, which in turn allows positioning of rivets 134 closer to the periphery of nose end 122. Positioning rivets 132 closer to the outer periphery of nose end 122 may thus increase the resistance of the nose end 122 to the side wall separation tendencies encountered when in operation.

FIG. 7 is an enlarged cross sectional view of an outer race in accordance with a fifth embodiment of the present invention. Outer race 228 includes an inner bore 236 and a plurality of teeth 240 disposed about the periphery. Each tooth 240 has an abbreviated leading edge 244 and an abbreviated trailing edge 246. Abbreviated leading edge 244 of one tooth and the abbreviated trailing edge 246 of an adjacent tooth form gullet 242. Abbreviated edges 244 and 246 have a substantially uniform pitch from an area close to the tooth tip 234, to the gullet termination point 258. Gullet 242 then has radius of curvature 256. Because leading and trailing edges 244, 246 are abbreviated, the radius of curvature 256 is larger than a conventional radius of curvature 259 that would be caused if the pitch of the leading and trailing edges continued in a substantially flat manner until the transition into the gullet (shown by broken lines and being substantially v-shaped). Though still somewhat v-shaped, the abbreviated leading and trailing edges 244, 246 result in a gullet having a more flat bottom that is more bowl-shaped, thereby having an increased diameter at the bottom of the gullet.

By increasing the radius of curvature and forming a more shallow bowl-shaped gullet, the radial forces will be urged toward the lower portion of the tooth and thereby allow the outer race to better resist the splitting forces, which in turn may prolong the life of the nose sprocket and/or enable decreasing the web width. Again, decreasing the web width allows the inner race diameter (not shown) to be increased. Increasing the inner race diameter will increase the resistance to side wall separation at the nose end of the guide bar because the rivets or other fixing means are positioned closer to the periphery of the nose sprocket.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

1-20. (canceled)

21. A nose sprocket adapted for engagement with a cutting chain drive tang, comprising:
a plurality of teeth formed in the nose sprocket, the plurality of teeth each having a leading edge and a trailing edge, the leading and trailing edges of the plurality of teeth each having a lower portion and an upper portion, the upper portion forming a relief;
a gullet between the lower portions of the leading and trailing edges of adjacent teeth; and
wherein at least a portion of the relief is adapted to protrude into the chassis of the chain defined by a bottom edge of a tie strap thereby providing lateral support for the chain, and wherein the relief causes the drive tang to contact at least one of the lower portions of the teeth and the gullet at substantially the same time.

22. The nose sprocket of claim 21, wherein the relief causes the drive tang to be supported at the lower portions and thus provides increased resistance to splitting at the gullet to enable increasing the inner bore diameter and increasing the radial dimension of the inner race while maintaining a predetermined circuitous path around the nose end.

23. The nose sprocket of claim 21, wherein the relief causes the drive tang to be supported at the lower portions and thus provide increased resistance to splitting at the gullet such that operational life of the nose sprocket can be prolonged.
